(19) United States
(12) Patent Application Publication
(10) Pub. No.: US 2006/0100771 A1
(43) Pub. Date: May 11, 2006

(54) Vehicle speed detection apparatus

(75) Inventor: Stephen Chen, Shengang Shiang (TW)

Correspondence Address: BRUCE H. TROXELL;SUITE 1404, 5205 LEESBURG PIKE, FALLS CHURCH, VA, 22041, US

(73) Assignee: E-Lead Electronic Co., Ltd.

(21) Appl. No.: 10/984,815

(22) Filed: Nov. 10, 2004

(51) Int. Cl. G06F 19/00; G06G 7/70

(52) U.S. Cl. 701/110

(57) ABSTRACT

A vehicle speed detection apparatus includes a vehicle power supply noise detection unit to detect the power supply noise frequency of a vehicle and an accelerometer to detect the acceleration value. And through an integral calculation an estimated instant vehicle speed may be derived to continuously perform navigation while GPS signal of the vehicle navigation apparatus is interrupted. The invention also provides plug and use convenience.

### BACKGROUND OF THE INVENTION

1. Field of the Invention

The present invention relates to a vehicle speed detection apparatus that uses a detected vehicle power supply noise frequency and a vehicle acceleration value to estimate the instant vehicle speed to enable the vehicle navigation apparatus to continuously perform navigation during the absent window of GPS signal interruption and provides plug and use convenience.

2. Description of the Prior Art

The general vehicle navigation apparatus processes signals transmitted from the satellites to obtain the longitude and latitude of the vehicle and locate the vehicle position on an electronic map in the vehicle to instantly indicate and guide the driving direction for the driver. However, the conventional vehicle navigation apparatus often encounters poor signal receiving or signal interruption due to geographic or road conditions, such as tunnels, overpass or alleys between the high rise buildings in the city. In such circumstances, the satellite signal cannot meet navigation requirements and the navigation apparatus becomes inoperable. To remedy this problem, some high class navigation apparatus 11 employ a gyroscope 12 and a detected vehicle speed line 13 to derive the driving position of the vehicle (referring to FIG. 1) and to compensate the lost signal of the satellite 14.

As the vehicle speed line 13 location and the signal format vary in different vehicles, troubles occur in the installation. Moreover, the general users often cannot install the high class navigation apparatus themselves. They have to pay an installation fee to hire professionals to do installation. It is not economic.

### SUMMARY OF THE INVENTION

In view of the aforesaid disadvantages, the present invention aims to provide a vehicle speed detection apparatus that can provide instant vehicle speed signals to the vehicle navigation apparatus in the absent window of GPS signal interruption to continuously perform navigation and provide a plug and use convenience without the help of professionals to overcome the installation difficulty of connecting the navigation system to the vehicle speed signals occurred to the conventional techniques.

The vehicle speed detection apparatus according to the invention includes at least a vehicle power supply noise detection unit to detect the vehicle power supply noise frequency, and through integral calculation to obtain estimated instant vehicle speed to enable the vehicle navigation apparatus to continuously perform navigation while the GPS signal is interrupted.

In one aspect, the vehicle speed detection apparatus according to the invention further includes an accelerometer so that the vehicle power supply noise frequency detected by the vehicle power supply noise detection unit and an acceleration value detected by the accelerometer may be processed by an integral calculation to obtain an estimated instant vehicle speed to enable the vehicle navigation apparatus to continuously perform navigation while the GPS signal is interrupted.

In another aspect, the vehicle speed detection apparatus according to the invention can be inserted in the lighter jack of the vehicle to obtain the vehicle power supply noise frequency. As the power supply is connected to the lighter jack, it also provides the power supply needed for the vehicle speed detection apparatus and the navigation apparatus to achieve plug and use convenience. In yet another aspect, the vehicle speed detection apparatus according to the invention further includes a navigation apparatus to be installed with the invention for the vehicles that do not have navigation apparatus previously. In still another aspect, the vehicle speed detection apparatus according to the invention includes a processing unit which may be contained in the navigation apparatus.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of a conventional vehicle navigation system.

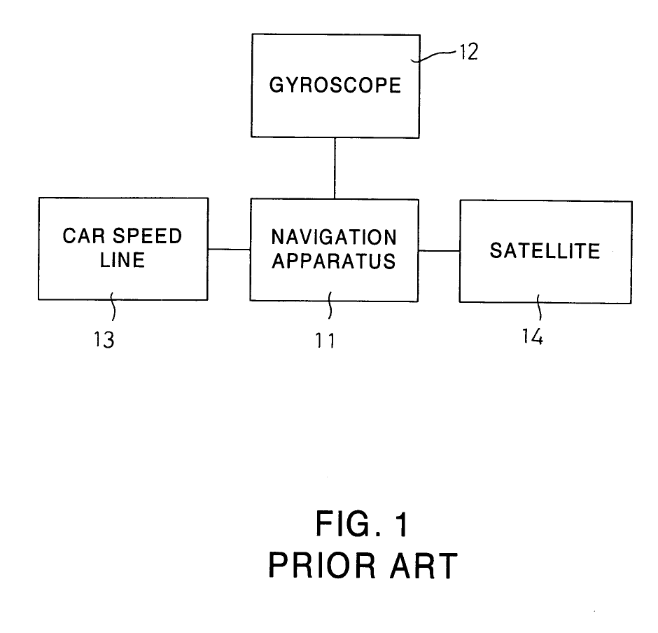

FIG. 2 is a circuit block diagram of the invention.

FIG. 3 is a circuit block diagram of another embodiment of the invention.

FIG. 4 is a chart showing a characteristic curve of the relationship of the engine speed and vehicle speed according to the invention.

FIG. 5 is a vehicle speed table showing the relationship of the gear shift and engine speed and vehicle speed according to the invention.

FIG. 6 is an operation flow chart of the invention.

### DESCRIPTION OF THE PREFERRED EMBODIMENTS

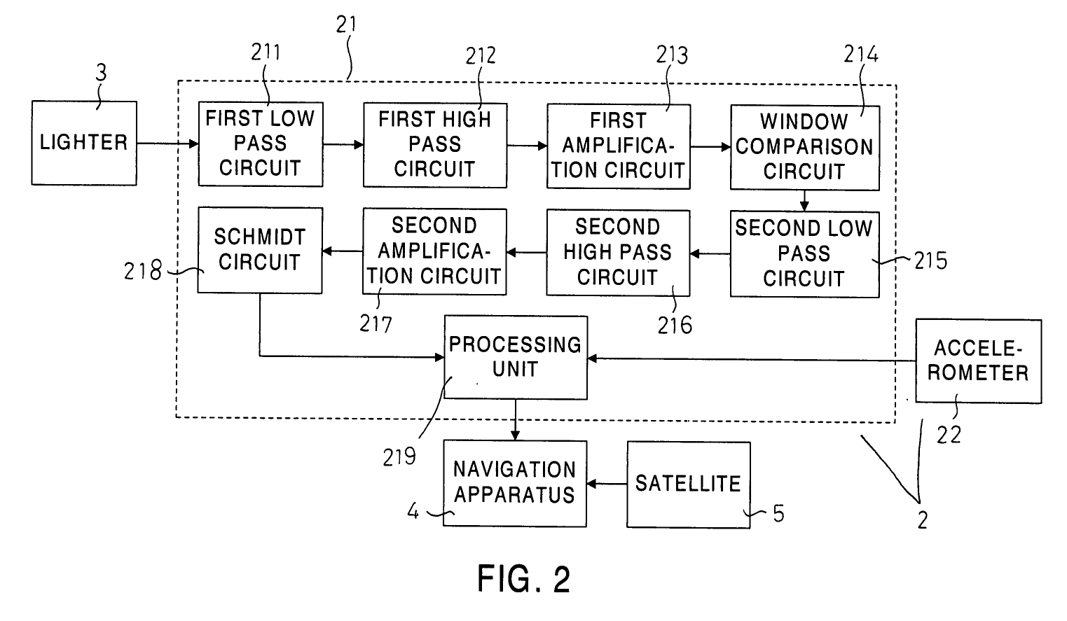

Refer to FIG. 2 for a circuit block diagram of an embodiment of the invention. The vehicle speed detection apparatus 2 according to the invention includes:
a vehicle power supply noise detection unit 21 to detect the existing noise frequency NF of the vehicle power supply and convert to engine speed ES to derive an estimated instant vehicle speed; and
an accelerometer 22 to detect a vehicle acceleration value a;

The vehicle power supply noise detection unit 21 includes:
a first low pass circuit 211 to filter out high frequency noises in the noise frequency NF;
a first high pass circuit 212 to filter out low frequency noises in the noise frequency NF;
a first amplification circuit 213 to amplify signals of the noise frequency NF to facilitate comparison;
a window comparison circuit 214 to generate a digital waveform for the waveform of the signals of the noise frequency NF;
a second low pass circuit 215 to filter out the high frequency noises of the signals of the noise frequency NF;
a second high pass circuit 216 to filter out the low frequency noises of the signals of the noise frequency NF;
a second amplification circuit 217 to amplify the signals of the noise frequency NF for facilitate comparison;
a schmidt circuit 218 to generate a digital waveform for the waveform of the signals of the noise frequency NF;
a processing unit 219 to transform the detected noise frequency generated by the generator to a digital signal, and process and derive an estimated instant vehicle speed Vt after having included the detected acceleration value a.

By means of the aforesaid elements, the invention may be directly coupled to a vehicle lighter jack 3 to obtain the vehicle power supply noise frequency NF and also obtain the power supply required for the invention. Thus the invention has the convenience of plug and use.

The vehicle power supply noise frequency NF detected by the vehicle power supply noise detection unit 21 may be originated from the generator or engine ignition. The generator speed relates to the engine speed ES. Hence the noise frequency NF and the engine speed ES have the following relationship:
ES=NF×r

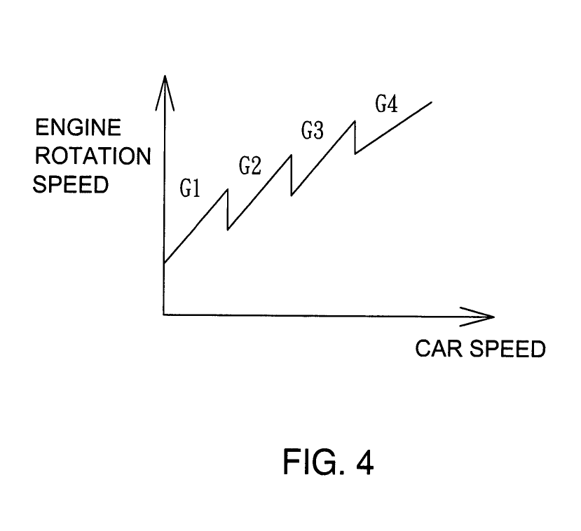

Namely, the engine speed ES is r times of the noise frequency NF, (where r is a parameter). The relationship of the detected engine speed ES and the vehicle speed CS can be grouped in several conditions (referring to FIG. 4) as follow:

1. Neutral gearshift condition: The engine is running, but the vehicle speed is zero.

2. First gearshift condition: The vehicle speed CS and the engine speed ES form a constant ratio G1, namely CS=ES×G1.

3. Second gearshift condition: The vehicle speed CS and the engine speed ES form a constant ratio G2, namely CS=ES×G2.

4. Third gearshift condition: The vehicle speed CS and the engine speed ES form a constant ratio G3, namely CS=ES×G3.

5. Fourth gearshift condition: The vehicle speed CS and the engine speed ES form a constant ratio G4, namely CS=ES×G4.

6. During switch of the gearshift: Whether switching from the lower gearshift to the higher gearshift, or from the higher gearshift to the lower gearshift, the clutch is disengaged or in a half-engaged condition, and the noise frequency NF changes suddenly. Hence there is no constant relationship between the engine speed ES and the vehicle speed CS. The vehicle usually is at an accelerating or decelerating condition. The acceleration value a may be detected from the accelerometer 22.

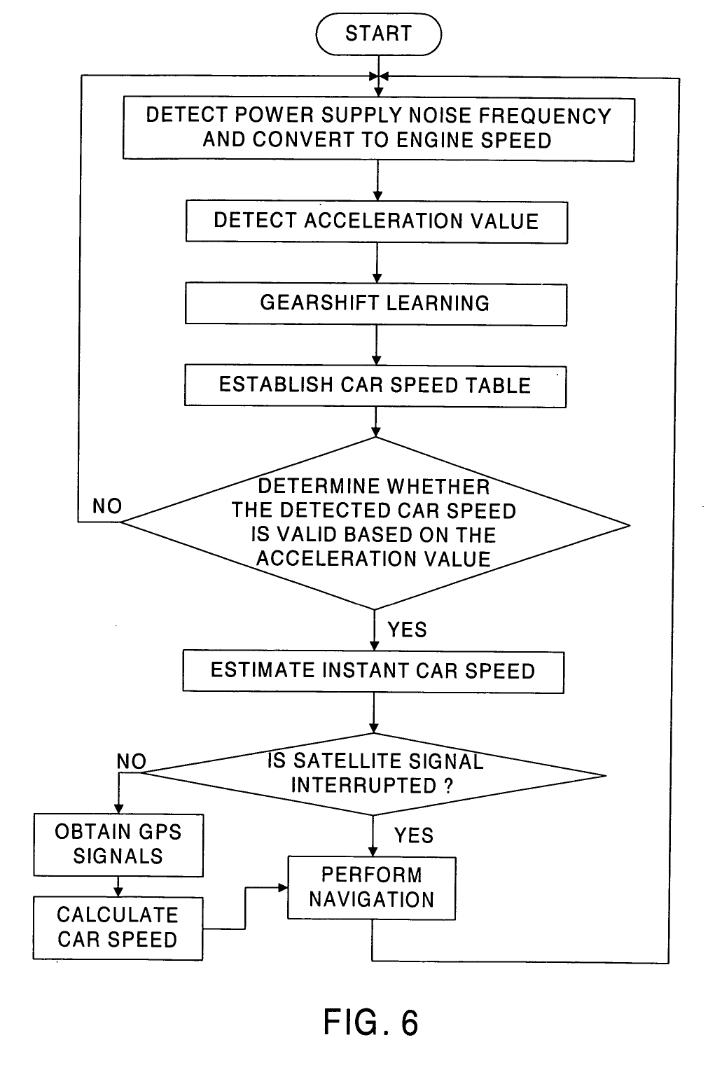

The relationship of the engine speed ES and the vehicle speed CS set forth above, aside from the conditions of stopping and accelerating and decelerating for changing the gearshift, there are also a number of non-continuous constant relationships between the engine speed ES and the vehicle speed CS (referring to FIG. 4). Those relationships between the engine speed ES and the vehicle speed CS may be detected if the signal of the satellite 5 is in a good condition, while the navigation apparatus 4 can accurately detect the vehicle speed CS, and the accelerometer 22 can detect that the vehicle has no obvious acceleration or deceleration. Referring to FIG. 6, the procedure is as follow:

1. Detect the power supply noise frequency: Detect the noise frequency NF through the power supply noise detection unit 21, and convert to the engine speed ES.

2. Detect the acceleration value: Detect the vehicle acceleration value a through the accelerometer 22. 3. Gearshift learning: When the GPS signal is available, the engine speed ES will have a speed difference during acceleration (suddenly drop and continuously increase, and the accelerometer 22 is accelerating). The speed provided by the GPS at that moment is the switch point of the gearshift. After a number of learning and memorizing (depending on requirements, preferably five to size times), a desired switch point may be derived based on the average of the learned values. Thereafter, whenever the detected speed is higher or lower than the switch point, the gearshift may be determined to obtain a comparison speed proximate to the actual value.

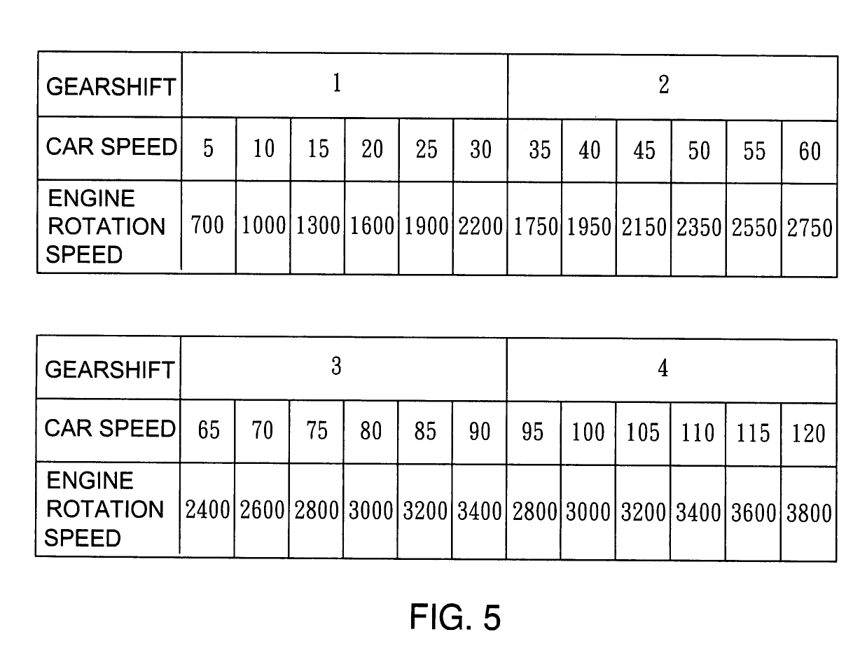

4. Establish a vehicle speed table: The relationship between the engine speed ES and the vehicle speed CS, in addition to the conditions of stopping and acceleration and deceleration for switching of gearshift, there are also a number of non-continuous constant relationships between the engine speed ES and the vehicle speed CS. Those non-continuous constant relationships between the engine speed ES and the vehicle speed CS may be detected if the signal of the satellite 5 is in a good condition, and the navigation apparatus 4 can accurately detect the vehicle speed CS, and the accelerometer 22 can detect that the vehicle has no obvious acceleration or deceleration, and a continuous straight line may be derived (referring to FIG. 4). Then a desired vehicle speed table for gearshift may be setup (referring to FIG. 5). Hence when the signal of the satellite 5 is interrupted, the engine speed ES may be derived from the vehicle power supply noise frequency NF, and the vehicle speed CS may be obtained from the vehicle speed table.

5. Determine whether the detected vehicle speed is valid based on the acceleration value a: The vehicle speed table is valid in the condition of the clutch having been engaged. The clutch engaging condition may be determined based on the accelerating condition of the vehicle that may be derived from the acceleration value a. For instance, if the reading of the accelerometer 22 is smaller than a setting value a0 (such as below 15) at a setting time T0 (such as three seconds), it may be determined that the vehicle is not accelerating and no switching of gearshift takes places, and the clutch is engaged. Therefore a constant relationship exists between the vehicle noise frequency NF and the vehicle speed CS, and the vehicle speed table may be used to derive the vehicle speed. On the contrary, if the aforesaid conditions were not met, it may be determined that there is no definite relationship between the noise frequency NF and the vehicle speed CS.

6. Estimate instant vehicle speed: After the derived vehicle speed CS is obtained from the vehicle speed table, the instant vehicle speed Vt may be derived by the integral total of the acceleration value a of the accelerometer 22. Vt=Vt−1 (the vehicle speed derived or confirmed at the preceding spot)+a (acceleration value) T (time interval). Based on the aforesaid procedure, the instant vehicle speed Vt may be derived for use in the navigation apparatus 4 even if the signal of the satellite 5 is not available.

7. Navigation execution:
(1) When the satellite signal is normal, the vehicle speed may be derived from the GPS signal to perform navigation.
(2) When the satellite signal is interrupted, the estimated instant vehicle speed Vt may be obtained through the invention to perform navigation.

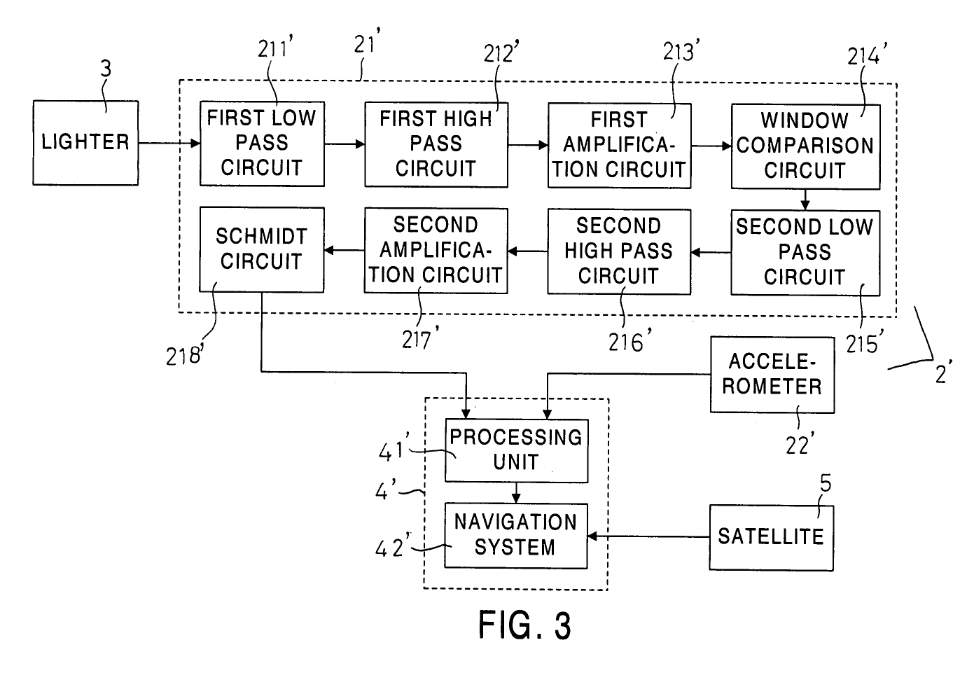

Refer to FIG. 3 for the circuit block diagram of another embodiment of the invention. The vehicle speed detection apparatus 2′ according to the invention includes a vehicle power supply noise detection unit 21′ and an accelerometer 22′. The vehicle power supply noise detection unit 21′ includes a first low pass circuit 211′, a first high pass circuit 212′, a first amplification circuit 213′, a window comparison circuit 214′, a second low pass circuit 215′, a second high pass circuit 216′, a second amplification circuit 217′, and a schmidt circuit 218′ that are largely like the embodiment previously discussed. The difference is in the processing unit 41′ which is located in a navigation apparatus 4′ to process and derive the instant vehicle speed Vt for use on a navigation system 42′.

I claim:

1. A vehicle speed detection apparatus comprising a vehicle power supply noise detection unit to detect an existing noise frequency of a vehicle power supply and convert to an engine speed to derive an estimated instant vehicle speed.

2. The vehicle speed detection apparatus of claim 1, wherein the vehicle power supply noise detection unit includes a processing unit.

3. The vehicle speed detection apparatus of claim 1 further including a navigation apparatus.

4. The vehicle speed detection apparatus of claim 1 further including an accelerometer to detect a vehicle acceleration value.

5. The vehicle speed detection apparatus of claim 1, wherein the vehicle speed detection apparatus is connected to a lighter jack to supply electric power for the vehicle power supply noise detection unit and detect the noise frequency.

6. The vehicle speed detection apparatus of claim 1, wherein the vehicle power supply noise detection unit includes:
a first low pass circuit to filter out high frequency noises in the noise frequency;
a first high pass circuit to filter out low frequency noises in the noise frequency;
a first amplification circuit to amplify signals of the noise frequency to facilitate comparison; and
a window comparison circuit to generate a digital waveform for the waveform of the signals of the noise frequency.

7. The vehicle speed detection apparatus of claim 6, wherein the vehicle power supply noise detection unit further includes:
a second low pass circuit to filter out the high frequency noises in the noise frequency;
a second high pass circuit to filter out the low frequency noises in the noise frequency;
a second amplification circuit to amplify the signals of the noise frequency to facilitate comparison; and
a schmidt circuit to generate a digital waveform for the waveform of the signals of the noise frequency.

8. A vehicle speed detection apparatus comprising a vehicle power supply noise detection unit to detect an existing noise frequency of a vehicle power supply and convert to an engine speed to derive an estimated instant vehicle speed and a navigation apparatus.

9. The vehicle speed detection apparatus of claim 8, wherein the navigation apparatus include a processing unit.

10. The vehicle speed detection apparatus of claim 8 further including an accelerometer to detect a vehicle acceleration value.

11. The vehicle speed detection apparatus of claim 8, wherein the vehicle speed detection apparatus is connected to a lighter jack to supply electric power for the vehicle power supply noise detection unit and detect the power supply noise frequency.

12. The vehicle speed detection apparatus of claim 8, wherein the vehicle power supply noise detection unit includes:
a first low pass circuit to filter out high frequency noises in the noise frequency;
a first high pass circuit to filter out low frequency noises in the noise frequency;
a first amplification circuit to amplify signals of the noise frequency to facilitate comparison; and
a window comparison circuit to generate a digital waveform for the waveform of the signals of the noise frequency.

13. The vehicle speed detection apparatus of claim 12, wherein the vehicle power supply noise detection unit further includes:
a second low pass circuit to filter out the high frequency noises in the noise frequency;
a second high pass circuit to filter out the low frequency noises in the noise frequency;
a second amplification circuit to amplify the signals in the noise frequency to facilitate comparison; and
a schmidt circuit to generate a digital waveform for the waveform of the signals of the noise frequency.
